(19) United States
(12) Patent Application Publication
(10) Pub. No.: US 2010/0008515 A1
(43) Pub. Date: Jan. 14, 2010

(54) MULTIPLE ACOUSTIC THREAT ASSESSMENT SYSTEM

(76) Inventors: David Robert Fulton, Ontario (CA); Paula Ann Hawes, Ontario (CA); Kenneth S. Lally, Honeoye Falls, NY (US)

Correspondence Address: Stephen B. Salai, Esq.;Harter Secrest & Emery LLP, 1600 Bausch & Lomb Place, Rochester, NY, 14604-2711, US

(21) Appl. No.: 12/170,914

(22) Filed: Jul. 10, 2008

(51) Int. Cl. H04R 3/00

(52) U.S. Cl. 381/92

(57) ABSTRACT

A system is provided for locating and identifying an acoustic event. An acoustic sensor having a pair of concentric opposing microphones at a fixed distance on a microphone axis is used to measure an acoustic intensity, from which a vector incorporating the acoustic event is identified. A second acoustic sensor or movement of the first acoustic sensor is used to provide a second vector incorporating the acoustic event. Combination of the first and the second vector locates the acoustic event in space. A command unit in communication with the acoustic sensors can be used for combining the vectors as well as comparing a signal spectra of the acoustic event to stored identified spectra to provide an identification of acoustic event.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention relates to passive monitoring systems, and more particularly to an acoustic sensor incorporating directional microphones for identifying an acoustic intensity vector to locate an acoustic event.

2. Description of Related Art

There are a variety of applications for which it is desirable to determine the approximate location of an acoustic source. For example, in recent years, U.S. military personnel have fought increasingly in non-conventional, urban warfare environment, wherein threat location is difficult to detect. Similarly, domestic law enforcement officers deal with lethal threats with increasing frequency. The lethality of sniper fire, for example, has not only been routinely encountered in Iraq, but, unfortunately, on the streets of US cities. In both of these situations, friendly forces are required to protect the innocent, and remove the threat with minimal collateral losses of life and property.

Acoustic techniques have been used to calculate potential acoustic source positions based on a time delay associated with an acoustic signal traveling along two different paths to reach two spaced-apart microphones. U.S. Pat. Nos. 6,600,824 and 7,039,1 98 disclose microphone arrays for locating a signal source, each of these patents being expressly incorporated by reference. However, resolution of ambiguity in acoustic source positions and sensitivity of prior systems has limited applicability in real time, environment independent systems.

The need remains for an acoustic monitoring system that can resolve acoustic event location ambiguities as well as provide a sufficiently robust system that allows deployment in hostile operating environments.

### BRIEF SUMMARY OF THE INVENTION

The present acoustic monitoring system provides an all-weather, network-centric passive acoustic sensor array for locating and identifying acoustic sources including human activity in a surrounding environment. Human activity produces characteristic acoustic signatures with distinctive patterns of intensity, frequency and duration, wherein the present system monitors these acoustic events to determine the location and nature of that activity.

It is contemplated the acoustic monitoring system can include an acoustic sensor having a pair of microphones separated by a fixed predetermined distance, the microphones facing each other on a common microphone axis MA and acoustically coupled to the environment. The acoustic sensor generates a signal representative of acoustic intensity through processing of the sound signals arriving at each microphone. The acoustic phase change between the two microphones combined with the measured sound pressure and sound intensity levels are used to estimate an incidence angle θ to the acoustic sensor.

The acoustic sensor provides a sound spectra received at each microphone in the pair as individual spectra in front of and behind the microphone pair, at the same point in time and global location. The acoustic monitoring system further includes a microprocessor in communication with the microphone pair; an absolute time clock, such as a GPS receiver (receiving a GPS signal), in communication with the microprocessor which provides synchronized (or absolute) time to the microprocessor. A position sensor, such as a GPS sensor is employed for detecting an absolute global position of the microphone pair and detecting an absolute axis orientation of the microphone pair. The acoustic sensor communicates with a network via a network interface in communication with the microprocessor, wherein an acoustic event received at the microphone pair results in the microprocessor transmitting a time of arrival, a microphone pair (acoustic sensor) absolute global position, a microphone pair axis orientation, and incidence angles measured by the microphone pair at frequencies within the received sound spectra, wherein the frequencies can be dynamically determined.

In a further configuration, the acoustic monitoring system includes a relative time clock in communication with the microprocessor, wherein the relative time clock provides synchronized time to a microprocessor in a second acoustic sensor. The relative time clock can include a receiver in communication with a transmitter, which is in communication with a microprocessor in the second acoustic sensor, wherein the second acoustic sensor is in communication with the absolute time clock, such as the GPS signal.

It is further contemplated the acoustic monitoring system can include two acoustic sensors, wherein one acoustic sensor produces a signal corresponding to an incidence angle (cos θ) with respect to an absolute point in time axis position for each sequentially received sound spectra. The acoustic monitoring system can be further configured so that the acoustic sensor provides a signal indicative of the incidence angle (cos θ) with respect to the absolute point in time axis position of the sensor for each sequentially received sound spectra, or selected spectral frequency focal points.

A method is provided for monitoring a noise source (acoustic event), wherein at least a pair of spaced acoustic sensors, each acoustic sensor having a pair of microphones separated by a predetermined distance, the microphones facing each other on a common microphone axis MA, measure an incidence angle and a command unit determines a position of the noise source corresponding to the measured incidence angle from each acoustic sensor.

In one configuration of the acoustic monitoring system, the passive acoustic sensor array provides for a wide area search of vehicles and dismounts in all possible environments including combat environments, with identification of hostile and friendly forces, and non-combatants, and means of delivering accurate tracking of potential targets and noncombatants near those targets.

Tactical deployment of multiple ground and air-dropped passive acoustic sensor arrays can be used to determine threat locations and to track and predict movements especially in close quarter or urban combat environments. The acoustic monitoring system provides real-time localization, identification and differentiation using acoustic intensity vector analysis at multiple acoustic frequencies within the sound spectra emitted by the acoustic event (or threat).

### BRIEF DESCRIPTION OF THE SEVERAL VIEWS OF THE DRAWING(S)

FIG. 1 is a schematic of an acoustic sensor and a command unit for the acoustic monitoring system.

FIG. 2 is a block diagram of the components of the acoustic monitoring system with analog/digital signal processing.

FIG. 3 is a block diagram of the components of the acoustic monitoring system with Fast Fourier Transform (FFT) signal processing.

FIG. 4 is a schematic representation of sound waves incident on a microphone pair in the acoustic sensor.

FIG. 5 shows an angle representing a cone along the microphone axis MA and projection on the surface of which the acoustic source is located.

FIG. 6 is a resulting 2-dimesional problem of source location from n acoustic sensors.

FIG. 7 is a graph of the potential location error for single acoustic sensor.

FIG. 8 is a graph of the potential location error for two acoustic sensors at separation distance of 3.0 meters.

FIG. 9 is a schematic view of the acoustic monitoring system showing a plurality of spaced acoustic sensors, acoustic signals from an acoustic event and a command unit.

### DETAILED DESCRIPTION OF THE INVENTION

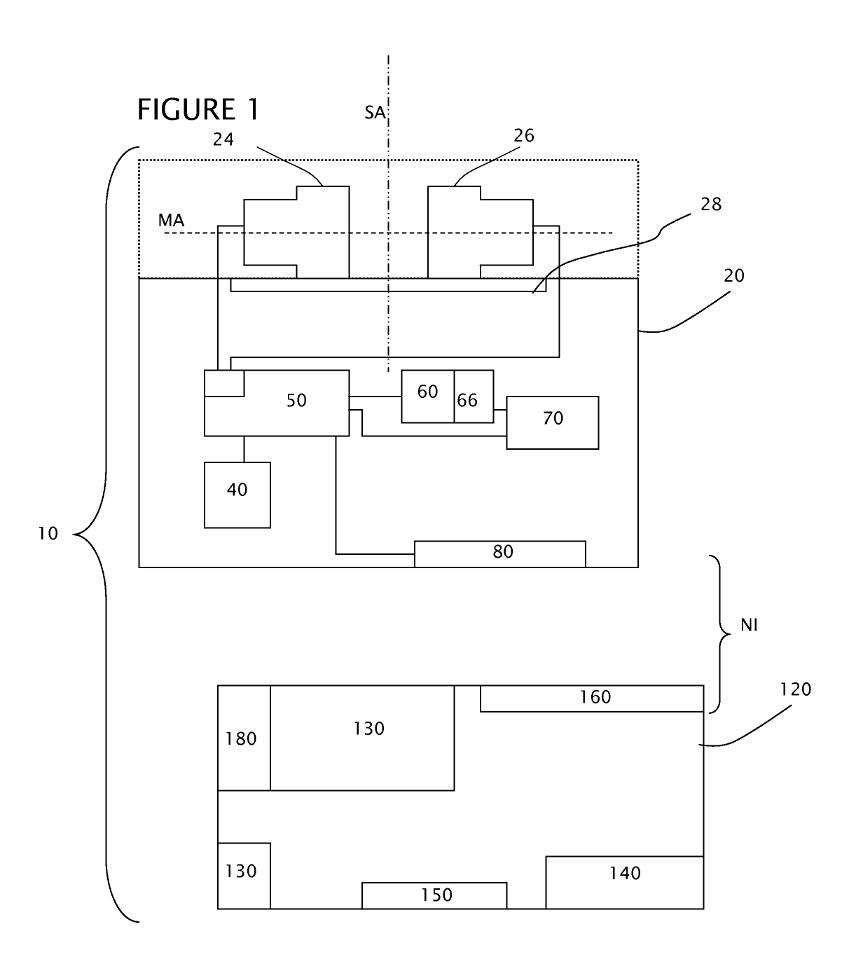

Referring to FIG. 1, the multiple acoustic threat assessment monitoring system 10 includes at least one acoustic sensor 20 and a command unit 120 for monitoring acoustic signals from an acoustic event.

The acoustic event is understood to include any mechanical vibrations transmitted by an elastic medium, such as sound generating activity including but not limited to human activity or environmental activity within the ambient environment. The acoustic event may also be classified as a noise or sound source which generates acoustic signals.

Acoustic Sensor

As shown in FIG. 1, the acoustic sensor 20 includes a housing 22 having a pair of matched microphones 24,26 in a fixed opposing orientation, wherein the microphones face each other along a common longitudinal microphone axis MA. The distance between the microphones 24,26 is fixed and the microphones are concentric (symmetric) about the microphone axis MA. The fixed distance between the microphones 24,26 can be provided by securing the microphones to a rigid substrate or plate 28. Preferably, the plate 28 has a known or negligible coefficient of thermal expansion over the intended operating temperature range of the acoustic sensor 20. Thus, the plate 28 can be formed of composites or laminates, as well as metals or alloys. Alternatively, the microphones 24,26 can be affixed to a spacer, which is located between the microphones to retain the fixed distance.

In one configuration, an acoustic sensor axis SA is located orthogonal to the microphone axis MA along which the microphones 24,26 are located. However, it is understood alternative orientations between the sensor axis SA and microphone axis MA can be used, as long as the orientation is fixed (unmoving) and known (or measured). Each microphone pair thus has a corresponding front and rear, with respect to a given acoustic event or source and hence the acoustic signals from the acoustic event. As seen in FIGS. 1, 2, and 8, the relative positions of the sensor axis SA, the microphone axis MA, the front and rear are shown.

The microphones 24,26 can be any of a variety of commercially available microphone constructions. The microphones 24,26 and any corresponding preamplifiers, filters and other electronics within the acoustic sensor 20 are amplitude-response and phase-response matched, so that the overall acoustic sensor provides a minimum pressure-residual intensity index of approximately 16 dB at 100 Hz, increasing with frequency to approximately 19 dB at 250 Hz and above. This corresponds to a phase matching of approximately 0.070 below 250 Hz, and varying approximately as

$$\frac{f}{3300}$$

in higher frequencies, where f is the frequency. Various commercially available microphones meeting international standard IEC 1043 “Class 1” requirements meet or exceed the requirements for incorporation in the acoustic sensor.

Each microphone pair 24,26 measures acoustic intensity and produces a corresponding signal. In addition, the microphone pair 24,26 monitors, or measures, the sound spectra from the front and rear of the microphone pair. The sound spectra typically includes an envelope in which a plurality of frequencies are present.

It is contemplated the acoustic sensor 20 can include a first microphone pair 24,26 having a first microphone axis MA and a second microphone pair having a second microphone axis MA, wherein the first microphone axis and the second microphone axis intersect at a predetermined angle.

The housing 22 can include a sealed portion 32 and an acoustically transparent portion or window 34. The acoustically transparent portion is intended to define the exposure of the microphone pair to the ambient environment.

The housing 20 retains a power supply 40 which can include a battery, such a lithium battery. Alternatively, the power supply 40 can include a capacitive storage device, a microscale solid oxide fuel cell, a microchannel energy generators or a fuel storage and delivery unit. Each of these power supplies being commercially available.

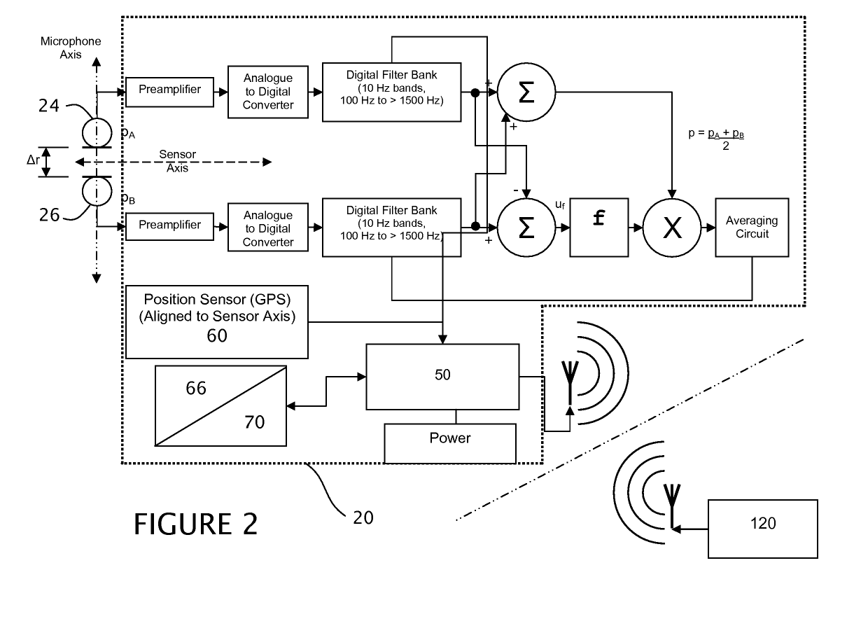

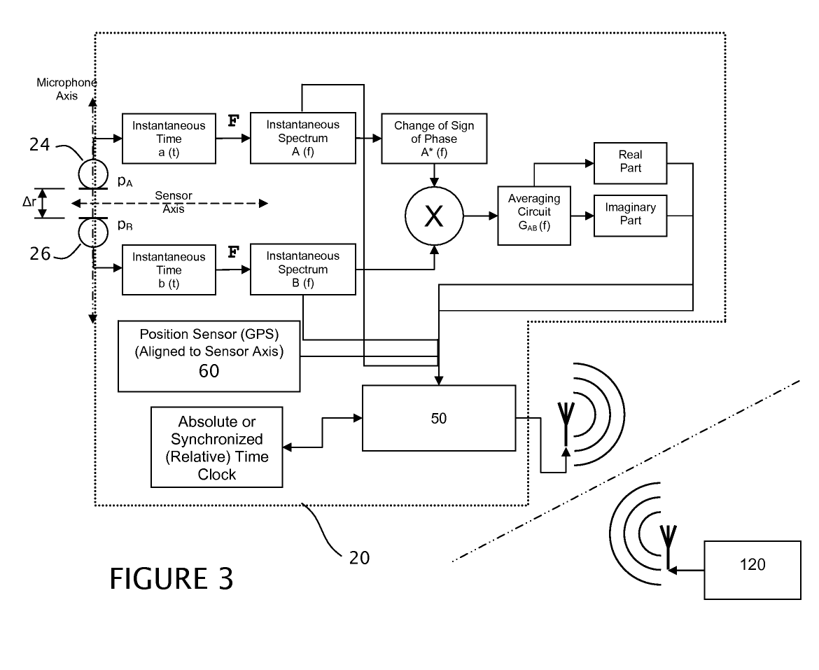

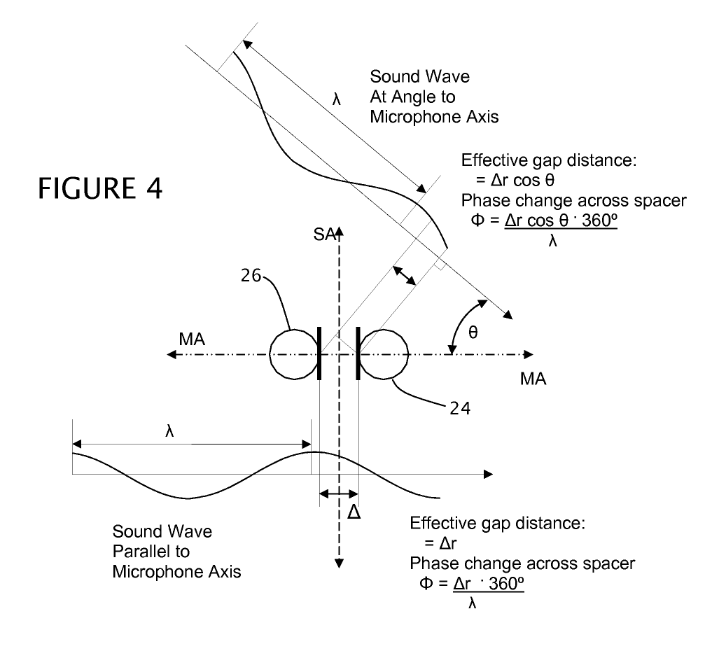

The acoustic sensor 20 includes a microprocessor 50, such as a dedicated microprocessor or a programmed microprocessor in communication with each of the microphones 24,26, and operably connected to the power supply 40. Typically, the microprocessor 50 is hard wired to the microphones 24,26. The microprocessor 50 can be configured to provide certain signal conditioning to the signals from the microphones 24,26. For example, the microprocessor 50 may alter the voltage, perform noise cancellation or active filtration of the signal representing the sound spectra from the microphones. Alternatively, separate components, as seen in FIGS. 1 and 2, can provide selected signal conditioning.

The acoustic sensor 20 also includes a GPS (Global Positioning System) sensor or receiver 60, wherein the GPS receiver provides an absolute clock 66 (via the GPS signal). By “absolute” clock it is meant the time is universal and synchronized from a single source, rather than generated at the sensor. The GPS receiver 60 is operably connected to the power supply 40 and the microprocessor 50. In one configuration, the GPS receiver 60 is fixed relative to the microphone axis MA; and hence the sensor axis SA. The GPS receiver 60 is a commercially available unit.

The microprocessor 50 can be configured to determine the orientation of the sensor axis SA relative to an absolute axis from the received GPS signals. In such construction, the sensor axis SA is typically calibrated to the GPS receiver 60, thereby providing the basis for determining or detecting an absolute orientation of the sensor axis SA. As the GPS receiver 60 is fixed relative to the microphone axis MA (and the sensor axis SA), the GPS receiver can provide a reference absolute axis for determination of the microphone axis MA relative to the absolute reference axis. Although set forth in terms of the sensor axis, it is understood the system can be employed in terms of the microphone axis.

The GPS receiver 60 communicates the position of the receiver and hence the position of the acoustic sensor 20 to the microprocessor 50. Also, the GPS receiver, or a second GPS receiver in the acoustic sensor 20 can be calibrated to provide a reference absolute axis for determination of the sensor axis SA relative to the absolute reference axis. Therefore, the GPS receiver 60 is fixed relative to the sensor and the sensor axis SA, so that the GPS receiver has a fixed orientation with respect to the acoustic sensor 20 and the sensor axis SA.

The acoustic sensor 20 can also include a relative clock 70 in communication with the microprocessor 50 such that the microprocessor can employ the relative clock for synchronizing with other acoustic sensors within the system 10. For example, the cooperative use of the absolute clock 66 and the relative clock 70 allow the microprocessor to obtain coordinated time (as distinguished from the synchronized time via the GPS) from the absolute clock so as to match similar sound frequencies (spectral frequency focal points) received at the microphone pair 24,26.

The acoustic sensor 20 also includes a transmitter and receiver for communicating with the command unit, as well as other sensors. While separate transmitters and receivers can be employed, to minimize the size of the acoustic sensor 20, it is contemplated a transceiver 80 can be employed for transmitting signals from the acoustic sensor 20 and receiving signals at the acoustic sensor. The transceiver 80 can be any of a variety of commercially available devices for operation at the designed frequency of the system 10. It is understood the transceiver 80 can be selected to operate over any frequency or combination of frequencies from sub-sonic to microwave. The transceiver 80 can cooperate with or provide for an encrypted trunk or frequency agile radio transmission. The transceiver 80 or transmitter-receiver pair can provide a network interface NI for communication of the acoustic sensor 20 with the command unit 120. It is understood the network interface NI can provide communication with other acoustic sensors within the system. Depending upon the specific configuration of the transceiver 80, the microprocessor 50 may act in cooperation with the transceiver to provide a network interface NI. Thus, the acoustic sensors 20 within the system 10 can create a network, or the acoustic sensors can communicate through a pre-established network. For example, the transceiver 80 can be configured to employ a cellular telephone network, ground wave radiofrequency communication network, power utility network, cable network or any networked non-ionizing radiation means of communication, such as infrared.

The microprocessor 50 can be configured and programmed with a unique encoded ID such that the transceiver 80 can selectively transmit the unique encoded ID. That is, the acoustic sensor 20 can identify itself to other acoustic sensors within a given system 10 as well as to the command unit 120.

The microprocessor 50 measures the GPS position of the acoustic sensor 20 and orientation using a front facing datum and the corresponding acoustic intensity in frequency intervals, creating a set of data-pairs. Each acoustic sensor 20, via the associated microprocessor 50, simultaneously scans the acoustic pressure received for digitizing. With respect to the position of the GPS receiver 60, the microprocessor 50 also obtains an absolute axis position of the sensor axis SA.

For sound incident at an angle of θ to the sensor axis SA, the intensity component along the axis will be reduced by the factor cos θ. For example, for sound incident at an angle of 0° to the sensor axis SA, the intensity level is reduced by approximately 0 dB, 30° to the sensor axis SA the intensity level is reduced by approximately 0.6 dB, 60° to the sensor axis the intensity level is reduced by 3 dB, and at 90° to the sensor axis the measured intensity level is zero (i.e., reduced by ∞).

Though not required, it is understood that a temperature compensation of the microphone pair 24,26 can be included and configured to reduce the minor uncertainty in the incidence angle. The temperature compensation can be provided by incorporation of a lookup table in the microprocessor 50 and a temperature sensor (not shown) in the housing, such that a given compensation is taken from the look up table in response to a measured temperature.

In use, either the acoustic sensor 20 (e.g., a mobile unit, or a unit worn by a user) or the noise source (i.e., the threat), or both are often in relative motion. Thus, measurement of the acoustic intensity as the orientation of the acoustic sensor 20 is tracked by the GPS signal which provides means of determining the vector (cos θ to sensor axis SA) back towards the acoustic event (such as a potential threat source), with an increasing intensity recorded when the acoustic sensor (wearer of the acoustic sensor) is moving directly towards the acoustic event (threat or source), or the acoustic event (threat) is moving directly along the sensor axis SA towards the stationary acoustic sensor. When both the acoustic sensor 20 and the source are stationary, the intensity will be represented by an unchanging vector to a static intensity source. When the source is approaching a stationary acoustic sensor 20 directly at 90° (left or right side), the intensity will increase with any movement along an unchanging vector, but as soon as the source leaves the “straight-in”, direct 90° path, the shift in cos θ will be detected as a much larger incremental, non-uniform decrease/increase in the source intensity. Movement of the source off any straight line path to the acoustic sensor 20, or the movement of the acoustic sensor along any vector (tracked by the GPS receiver 60) will result in a predictable corresponding decrease/increase in the apparent source intensity. Thus, the physical motion used in a routine “scan for threats” such as but not limited to the technique commonly referred to as “slicing the pie”, common to military and law enforcement alike, will provide a predictable and detectable change in the acoustic intensity which can be utilized to determine the vector to the source (threat). The acoustic sensor 20 can be configured as a two axis device (at 90°) and electronically scanned from each axis to simulate movement to detect flanking sources without risking movement by the respective acoustic sensor.

Intensity adjustments are unnecessary when the sensor axis SA is deflected from the 90° (horizontal) forward facing direction relative to the (standing erect) user axis, such as when the wearer is leaning forward, reclined or prone, but signal amplification may be required for spectral data capture.

In one configuration, each acoustic sensor 20 transmits an encrypted, frequency agile low-power radiofrequency information packet (data) containing the following information: (i) a start of data packet indicator; (ii) a digitized acoustic sensor ID; (iii) a digitized sensor GPS-derived 3-dimensional position at the time of measurement (2-D default location in the event the GPS signal is lost, the acoustic sensor sends the last known GPS coordinates until 2-D GPS signal is regained); (iv) a digitized acoustic intensity at various frequency intervals; (v) digitized acoustic pressure (signal spectrum); (vi) remaining electrical voltage/power; and (vii) a check sum and end of packet signal. This information packet can be transmitted for each cycle of the acoustic sensor 20.

The data transmitted by the acoustic sensor 20 can include a time of arrival of a given (or relevant frequency), a sensor absolute global position, a sensor axis SA orientation, and acoustic incidence angles measured by the microphone pair 24,26 at a single or a plurality of focal frequencies within the received sound spectra as determined by the microprocessor 50, wherein the focal frequencies may be predetermined or dynamically determined by the microprocessor, or from a signal from the command unit 120.

In addition, on interrogation by the command unit 120, such as by radiofrequency, each acoustic sensor 20 can transmit a signal, such as by encrypted burst non-audible sound or radio frequency signal, containing the sensor ID as a secondary sensor locator and “friendly” squawk and the GPS position (current or last known). It is contemplated a dismount manually actuated emergency locator beacon transmission capability, such as by non-audible sound or radio frequency signal, can be incorporated into the acoustic sensor 20, with appropriate “duress” verification of emergency transmissions.

It is further contemplated that the incidence angle corresponding to a selected spectral frequency can be provided by the acoustic sensor 20. The selected spectral frequency can be identified by the microprocessor 50 or the command unit 120 and communicated to the acoustic sensor. By monitoring only certain frequencies, the amount of data that must be processed and analyzed is reduced thereby increasing the responsiveness of the acoustic monitoring system 10. Correspondingly, a plurality of spectral frequency focal points or ranges can be identified, wherein the plurality of ranges is analyzed to identify a vector corresponding to the incidence angle θ, without requiring processing or analysis of the data of the non-selected frequencies.

Command Unit

Referring to FIG. 1, the command unit 120 includes a central processor 130, a display 140, a user interface 150 and a corresponding transmitter/receiver or transceiver 160 for communicating with each of the acoustic sensors 20 in the acoustic monitoring system 10. The central processor 130 can be a dedicated processor or a laptop computer programmed in accordance with the present disclosure. The display 140 can be incorporated into the laptop computer or can be a separate display such as, but not limited to LCD, Plasma, DLP, LCOS, D-ILA, SED, OLED and CRT displays. The user interface 150 can be any of a variety of available interfaces such as, but not limited to keyboards, pointing devices as well a body sensing devices. In conjunction with the transceiver 80 of the acoustic sensor 20, the transmitter and receiver pair (or transceiver 160) of the command unit 120 can operate using at least one frequency between sub-sonic and microwave. Thus, the frequencies can range within the ultrasonic range from approximately 20 Hz to approximately 300 GHz.

The command unit 120 further includes or is operably connected to a power supply 170. The power supply 170 can be a rechargeable battery or a line power. The command unit 120 also includes connected or integral memory 180 for storing both data from the acoustic sensors 20 as well as libraries of spectral distribution characteristics and look up tables. The libraries of spectral distribution characteristics can include known sound spectra for threats (e.g., weapons, vehicles) and hostile/neutral force speech patterns including common phrases in the anticipated local languages and dialects.

The basis of operation of the acoustic monitoring system 10 derives from the following relationship from standard sound intensity theory:

$$( {L}_{i} - {L}_{p } ) + 10 log ( \frac{ρ c}{400} ) = 10 log ( \frac{λ}{Δ r} \cdot \frac{φ}{360} ) ; where$$

Lₚ=average acoustic pressure measured by the two microphones 24,26;
Lᵢ=the acoustic intensity measured in the direction of the microphone axis MA;
ρ=density of the air at the current temperature and pressure;
c=speed of sound at the current temperature and pressure;
λ=the wavelength of the sound;
φ=the acoustic phase change across the spacer; and
θ=the angle of incidence between the sound wave and the microphone axis MA.

Substituting for φ at the incidence angle, and solving for θ yields:

$$θ = {cos}^{- 1} ( {10}^{( \frac{- \vert Li - Lp \vert}{10} + log ( \frac{ρ c}{400} ) )} )$$

Negative values of (Lᵢ−Lₚ) indicate that the noise source is “in front of” the acoustic sensor 20. Positive values indicate the source is “behind” the acoustic sensor 20.

As set forth above, theta (θ) is the angle of incidence (incidence angle) of the sound wave to the microphone axis MA (i.e., the angle from the microphone axis to the sound source (the acoustic event)). Thus, from the average sound level data (Lₚ) and acoustic intensity data (Lᵢ) transmitted by the acoustic sensor 20 to the command unit 120, the command unit can calculate values of θ for the 90 data-pairs. Alternatively, this data is also calculated and provided by the microprocessor 50 at the acoustic sensor 20. That is, the microprocessor 50 can calculate the values of θ. Combined with the sensor location and sensor orientation, this calculation of θ provides a directional axis from the microphone axis MA to the sound source for that acoustic sensor 20.

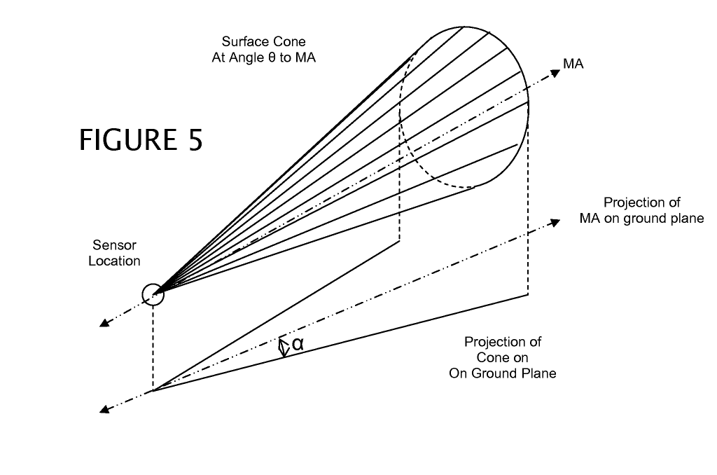

Due to symmetry around the microphone axis MA and as seen in FIG. 5, in general the angle θ represents a cone along the microphone axis on the surface of which the source in question is located, rather than a simple vector. Therefore, for n acoustic sensor locations, the source location (acoustic event) can be estimated though calculating the least-squares fit intersection of the n cones. This can be accomplished through standard boundary finding algorithms.

In general, the microphone axis MA will be close to parallel to the plane of the ground, and thus for the majority of the time, the sound source (acoustic event) and the acoustic sensor 20 will be at similar elevations. Therefore, the solution can be simplified to a 2-dimensional problem, by considering the projection of the cone on the ground plane, as shown in FIG. 5.

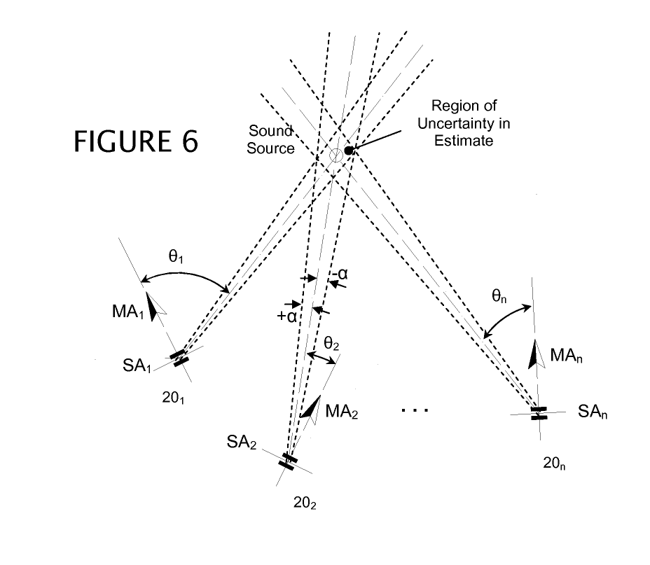

Alternatively, the viewable angle of the microphone pair 24,26 in the acoustic sensor 20 can be restricted to define the exposure of the microphone pair. This restriction can also provide the mechanical equivalent of the 2-dimensional projection. The resulting 2-dimesional problem of source location from nacoustic sensors is shown in FIG. 6.

For each acoustic sensor 20, there are two intercept lines radiating out from the microphone axis MA at an incidence angle θⱼ. One of the intercept lines will pass through the source location (the origination of the acoustic event).

Given the n^{th} acoustic sensor x, y-location, the sensor axis SA orientation, and the incidence angle θₙ, the two lines radiating from the n^{th} acoustic sensor can be represented in an arbitrary common Cartesian co-ordinate system as two lines with the form:

yₙᵢ=mₙᵢ xₙᵢ+bₙᵢ

where mₙᵢ=slope of the l^{th} line from the n^{th} sensor

bₙᵢ=y-intercept of the l^{th} line from the n^{th} sensor

l=1 or 2, representing the two possible intercept lines

Standard Universal Transverse Mercator (UTM) co-ordinates can be used, which will be readily available from the GPS system, or an arbitrary co-ordinate system can be assigned by the command unit.

Only one of the two intercept lines from each acoustic sensor 20 is the actual vector intercepting with the source location. The actual vector intercept line from each acoustic sensor 20 can be determined through a number of methods, and the “incorrect” line discarded. For example (i) the previous measurements of the source location can be used to determine which is the likely actual intercept line; or (ii) the intercept lines can be compared against those from adjacent acoustic sensors, wherein lines which do not form intersections with at least one line from an adjacent acoustic sensor are “incorrect”. This can be quickly done in a pair-wise fashion to determine which intercept lines are actual. These methods are representative as other methods can be employed within the scope of the invention.

Once the likely or “correct” intercept lines are determined, the source location can be determined by finding the intercept of the remaining n intercept lines. Uncertainties in determining x, y-locations of each acoustic sensor, the sensor axis SA, as well as the measurements of sound pressure level and acoustic intensity result in uncertainty in the estimated intercept angle θ for each acoustic sensor 20. Thus the n individual intercept lines are unlikely to cross at the same point in 2-dimensional space. Therefore, a “least-squares” approach must be used to determine the approximate source location.

One such solution is a Moore-Penrose pseudo-inverse (also known as a “generalized inverse”). Re-writing the intercept equations into the form ax+by=c and
Let A_{n×2}=the matrix of a and b values for the n sensors
C_{n×1}=the column vector matrix of c values for the n sensors
S_{n×1}=the column vector matrix of the solution,
   Then the least-squares fit solution is given by:

S=(A^{T}A)⁻¹A^{T}C

Other methods can be used as well as other available mathematical approaches to determine mathematical uncertainty.

As previously set forth, it is contemplated the acoustic sensor 20 can incorporate a second pair of microphones at a set angle to the first pair of microphones, such as at 90° angle to the first microphone axis MA. The second set of microphones could be used in a similar manner as the described above to calculate a height above the ground plane, completing the 3-dimensional solution of the source location. Alternatively, if boundary finding algorithms will be used to solve the 3-dimensional cone problem, the 2-dimensional solution S can be used as a seed value to speed the calculations.

As discussed previously, the uncertainty in identification of source location S is a function of the uncertainty in the estimate of incidence angle θ. The uncertainty in estimating θ includes the uncertainties in estimating position, the sensor angle, and sound pressure and acoustic intensity values, as these are all dependant variables.

The average error in determination of intercept angle θ is the value α. The effect on source location determination is shown in FIG. 6. The estimated intercept angle θ will have an associated uncertainty of ±α. The effect is to create a region of uncertainty in the estimation of the source location. The farther the source is from the acoustic sensor 20, the greater the uncertainty in prediction. The greater the number of acoustic sensors n, and the greater the spread of the acoustic sensors, the lower the uncertainty.

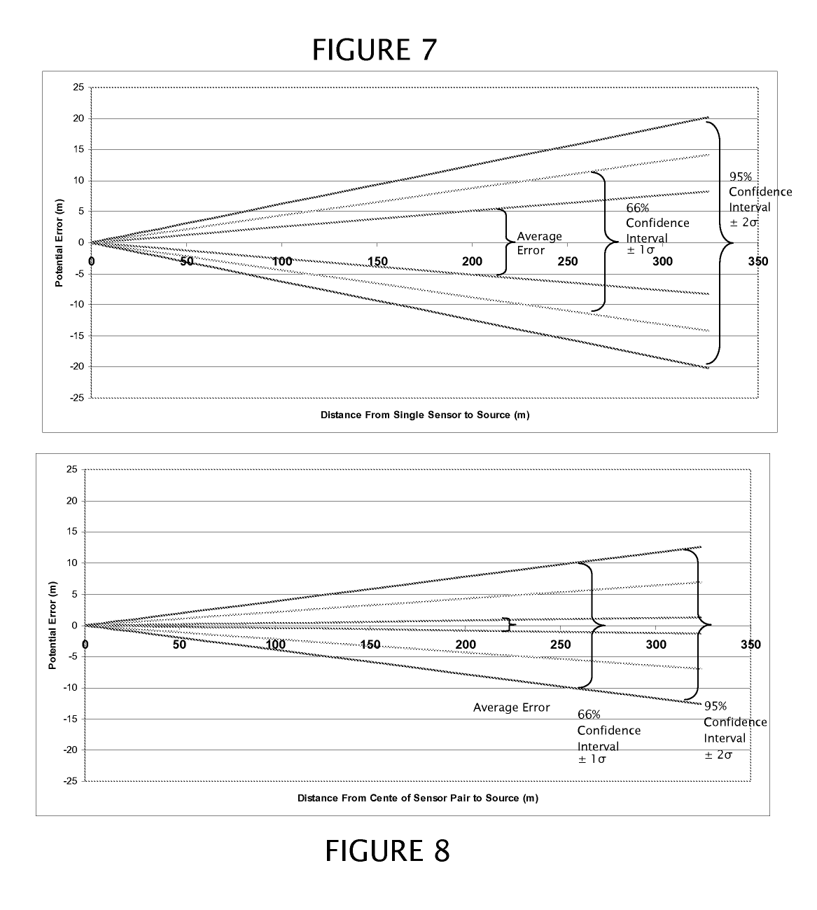

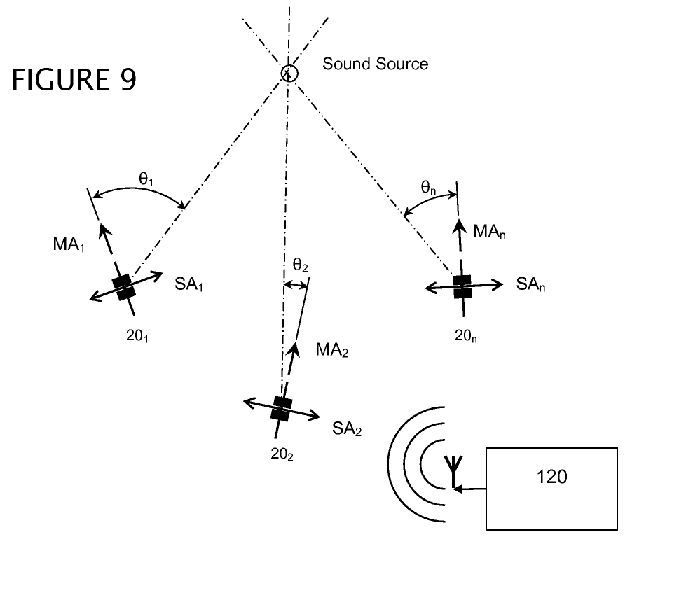

Experimental data indicates an α value for the acoustic monitoring system of less than 1.5°, with a standard deviation of ˜1°. The resulting average error in source location for a acoustic sensor is show in the following table and graphically in the FIGS. 7 and 8.

| | | | | Average Error, | |
|---|---|---|---|---|---|
| | | Average Error, | | Two Probes at 3.0 m | |
| Source to Probe Distance | | Single Probe | | Separation distance | |
| (m) | (ft) | (m) | (ft) | (m) | (ft) |
| 1 | 3.3 | 0.03 | 0.1 | 0.001 | 0.004 |
| 4 | 13.1 | 0.1 | 0.3 | 0.005 | 0.02 |
| 9 | 30 | 0.2 | 0.8 | 0.01 | 0.04 |
| 16 | 52 | 0.4 | 1.3 | 0.02 | 0.06 |
| 25 | 82 | 0.6 | 2.1 | 0.03 | 0.10 |
| 36 | 118 | 0.9 | 3.0 | 0.04 | 0.14 |
| 49 | 161 | 1.3 | 4.1 | 0.06 | 0.20 |
| 64 | 210 | 1.6 | 5.4 | 0.08 | 0.26 |
| 81 | 266 | 2.1 | 6.8 | 0.10 | 0.32 |
| 100 | 328 | 2.6 | 8.4 | 0.12 | 0.40 |
| 121 | 397 | 3.1 | 10.1 | 0.15 | 0.48 |
| 144 | 472 | 3.7 | 12.1 | 0.18 | 0.58 |
| 169 | 554 | 4.3 | 14.2 | 0.21 | 0.68 |
| 196 | 643 | 5.0 | 16.4 | 0.24 | 0.78 |
| 225 | 738 | 5.7 | 18.9 | 0.27 | 0.90 |
| 256 | 840 | 6.5 | 21.4 | 0.31 | 1.02 |
| 289 | 948 | 7.4 | 24.2 | 0.35 | 1.16 |
| 324 | 1063 | 8.3 | 27.1 | 0.40 | 1.30 |

In operation, the command unit 120 receives an information packet from a respective acoustic sensor 20 and determines the absolute position of the acoustic sensor from the received GPS data. Specifically, the command unit 120 receives the information packet and determines the absolute sensor position, primarily from the GPS data.

The data representing the position of the acoustic sensor 20 is transmitted to the command unit 120 when sufficient satellite signal is acquired by the acoustic sensor to determine the sensor position in three dimensions (3D) or location in two dimensions (2D) in the external environment. The acoustic sensor 20 transmits a last known GPS position (i.e., the sensor stored value) when the GPS 2D fix is lost, and the position is then approximated by the command unit 120 by multiple methods or approximations until a probable fix is determined compared to the last known sensor GPS position. These approximations include, in order of priority; (i) acoustic intensity detection by adjacent acoustic sensors with friendly designation provided by comparison of the detected acoustic spectrum and, if employed, that of the dismount/vehicle stored at the command unit prior to deployment, (ii) by movement tracking and prediction from prior GPS fixes, and finally (iii) as a fail-safe, by the non-audible or radio frequency beacon provided by the encrypted frequency agile transmitter to the command unit activated on demand when GPS signals are lost.

The capability for relative position determination to known GPS located acoustic sensors using acoustic detection by the adjacent sensors (with the adjacent acoustic sensors having a 3D fix) with friendly designation derived from sensor acoustic spectra stored at the command unit, and as necessary by ground unit to ground unit voice/radio challenge permits extension of the multiple acoustic threat assessment system inside buildings and areas with poor or no GPS coverage.

The command unit 120 receives the signals, such as radiofrequency signals bearing the information packet, from each acoustic sensor 20, decrypts the signal and extracts the sensor ID, the intensity of the measured acoustic intensity and the location/position of measurement data of the acoustic sensor and calculates the reverse vector to the multiple sound sources at each discrete focal frequency. The then current location of the acoustic sensors 20 is plotted with the vectors to significant sound sources (acoustic events), and the points of intersection of the reverse vectors calculated to determine the origins of the sound sources. Any single vector without an intersecting cross-vector from another acoustic sensor is also plotted for future consideration. Intensity (z) and position (x, y) data pairs are used for intensity contour mapping to develop a three dimensional VDT display of the battlefield superimposed on topographic maps, with friendly forces shown by sensor ID, and threats marked accordingly. Acoustic or sound sinks can also be identified at the command unit. Sound sinks are areas which obstruct and absorb sound and represent obstacles and potential areas of cover for hostile/neutral and friendly forces.

The command unit 120 can send signals to the acoustic sensors 20 to identify focal frequencies or range of frequencies for which to draw vectors. For example, a first or lead acoustic sensor 20 can conduct the spectral analysis and identify focal frequencies, wherein such focal frequencies are transmitted to the command unit 120. The command unit 120 in turn instructs the remaining acoustic sensors within the acoustic monitoring system 10 to examine the selected focal frequencies at a certain absolute time to identify the corresponding appropriate vectors.

While one configuration provides for communication from a given acoustic sensor 20 to the command unit 120 wherein the command unit then instructs corresponding acoustic sensors within the array, it is contemplated direct acoustic sensor to acoustic sensor communication can be employed. Such acoustic sensor to acoustic sensor communication depends at least in part upon the intended operating parameters of the acoustic monitoring system 10 as well as the available design parameters for incorporating the associated processor power and antennas.

In the command unit 120, the data from the acoustic sensors 20 can be acquired using a multi-channel analyzer. This data gathering arrangement can be used to successfully acquire, store and process data from multiple acoustic sensors 20. The data gathering algorithms include those known in the industry and are selected to introduce minimal delay in the overall data processing.

The data will be acquired, saved, processed (such as producing a threat situation map) and displayed at the command unit 120. It is contemplated the processed threat situation map can be selectively transmitted to each acoustic sensor 20 or to only selected acoustic sensors.

Generally, undesirable background acoustic signals are electronically removed to enhance signal detection selectivity and sensitivity, thereby providing greater accuracy in the determination of the noise source (acoustic event) location. Although high levels of steady background noise do not negatively impact intensity measurements, excessively intense or varying levels of background noises can be electronically attenuated to levels which can be processed. The filtering can occur at the acoustic sensor 20 by the microprocessor 50 or at the command unit 120.

The command unit 120 can also include a library of identified spectral distribution characteristics. The spectral distribution characteristics can include location of frequency peaks, number of frequency peaks, relation, such as time between and relative amplitude, of frequency peaks. The library of spectral distribution characteristics can be stored in a connected memory or integral memory in the command unit. The command unit 120 can also screen acoustic pressures (signal spectrum) against libraries of known sound spectra for threats (e.g., weapons, vehicles) and hostile/neutral force speech patterns for common phrases in the local languages and dialects, with presentation of the nature of the probable threat, a qualitative estimate of match reliability, and in the case of speech, the language translation. Certain frequencies characteristic of known friendly and enemy weapon systems can be pre-programmed for priority screening.

An application of the acoustic monitoring system 10 includes the use of local phraseology in the library to provide real-time translations of conversations received at the acoustic sensor. Thus, conversations captured by the acoustic sensor can be understood by users who do not speak the local language or dialect. Similarly, knowledge of the approximate number of persons gathered in a group, the predominance of an individual's voice pattern indicative of the presence of a leader (e.g., intensity, frequency patterning, and duration), and characteristics of the group movement, coupled with information regarding any weapon systems present provides additional threat level assessment information through acoustic cues.

In certain configurations, the data is passively collected from mobile and/or stationary field deployed acoustic sensors 20 and transmitted via secure frequency-agile radiofrequency transmission to the command unit which assesses and visually displays the battlefield tactical situation in real-time. The command unit 120 can create a visual display of the processed vector location of the source (or threat) situation map, which display can be transmitted to an individual acoustic sensor 20. However, the visual display of the processed vector location of the acoustic event (source) can be limited to display at the command unit 120. Tactical information and command decisions can be transmitted back to friendly forces by conventional radio communication, with narrow band video uplink to ground commanders and broadband video uplink to command headquarters.

In one configuration of the system 10, at least two acoustic sensors 20 are employed, wherein each acoustic sensor includes the microphone pair 24,26 and, in conjunction with the corresponding microprocessor 50 of the acoustic sensor, produces a signal corresponding to the incidence (acoustic intercept) angle (cos θ) with respect to the sensor axis SA position at an absolute point in time. The remaining acoustic sensor 20 can be instructed to match similar sound frequencies received “simultaneously” or within a given time domain.

In a further configuration, the acoustic sensor 20 can be disposed on a mobile device. During operation, such acoustic sensor 20 produces a signal corresponding to the incidence angle (acoustic intercept) angle (cos θ) with respect to the absolute point in time axis position of the acoustic sensor for each sequentially received sound spectra, wherein the microphone pair produces an individual sound spectra from the front and rear of the microphone pair. The microprocessor 50 processes the signals received from the microphones 24,26 and further obtains a synchronized time from the absolute clock to match similar sound frequencies received sequentially at different absolute global positions of the moving acoustic sensor.

The present system 10 thus provides a method for 360° directional acoustic event detection. In the method, selected frequencies or ranges within the spectra of acoustic events in front or behind the acoustic sensor 20 can be selectively filtered. Separate front acoustic spectra and back acoustic spectra from the acoustic sensor 20 are communicated to the command unit 120, wherein the command unit employs a combination of the monitored sound pressure within the monitored frequencies and a continuously variable degree of heterodyne sum and difference of the sound pressure received by the individual microphones of the acoustic sensor at selected identical or similar frequencies and a common absolute or relative time of arrival of the acoustic event.

The acoustic monitoring system 10 provides an additional method for locating the source of an acoustic event or a plurality of events. In this method, at least two acoustic sensors 20 are employed, wherein a known or anticipated acoustic event (frequency spectra) is received at each acoustic sensor. Each acoustic sensor 20 transmits a time of arrival of the acoustic event to the command unit 120. The time of arrival can be obtained from the relative clock of the acoustic sensor 20 or from the absolute clock. In addition, each acoustic sensor 20 transmits the paired acoustic intercept angle (incidence angle) and frequency corresponding to the time of arrival. The command unit 120 triangulates the location of the source of the acoustic event corresponding to the determined acoustic intercept angle for the selected frequencies and a time of arrival at the respective acoustic sensor 20.

The present system 10 further provides for the determination of spatial uncertainty of an acoustic wave source from the presence of sound transmission path modifications, such as but not limited to non-direct or multi-path transmission, wherein the determination results from the time of arrival of a particular frequency or group of frequencies (and signal duration) within a received acoustic event at two or more acoustic sensors 20. In this method, an acoustic event generates corresponding acoustic waves or signals. The acoustic waves are received at respective acoustic sensors 20. The received acoustic waves are converted to a digital representation representing the frequency domain signal of the acoustic wave. The digital representation is processed to reduce ambient acoustic interference, such as by inverting the signal. The processing can be performed at the microprocessor 50 within the acoustic sensor 20, or after transmission of the digital representation to the command unit 120.

Upon processing of the digital representation, the command unit 120 correlates a time of arrival of the received acoustic wave for the acoustic sensors within the monitoring system 10. If the time of arrival of signature peak(s) and signal duration do not correlate with the characteristics of the acoustic wave having the shortest time of arrival, the command unit 120 then provides an assessment that the acoustic waves arrived at the other acoustic sensors by means other than a direct path and whether the time of arrival alone would present a significant error in a calculation, such as by triangulation, of the acoustic event source.

By virtue of the stored library of spectral distribution characteristics, the present system 10 can assist in identifying the source of a detected acoustic event. For example, the acoustic waves generated by the acoustic event are received at the sensor and converted into a digital representation of the frequency domain signals. The digital representation can optionally be processed to increase detection sensitivity by reducing ambient acoustic event interference. The digital representation is then compared or correlated to stored spectral distribution characteristics and envelope characteristics. If a predetermined number of characteristics of the digital representation, frequency peaks, time between frequency peaks within the digital representation and signal duration sufficiently correlate with the characteristics of the stored spectral distribution characteristics, the monitoring system will identify the acoustic waves corresponding to the stored spectral distillation characteristics.

By deploying multiple acoustic sensors 20, such as dismount or vehicular mounted acoustic sensors, or as stationary or air/dismount placed listening acoustic sensors, multiple sound intensity vectors are measured “simultaneously” and with appropriate centralized data processing and interpolation, three-dimensional animated plots of the positions of sources (acoustic events) such as potential threats, non-combatants, and friendly forces are obtained in real-time. Individual threats (sources) are detected by the presence of common frequency signatures and localized by analyzing the acoustic intensity vectors at discrete frequencies within the associated frequency signature, which appears in the data stream from multiple acoustic sensors 20. In practice, all audible frequencies in a defined, narrow frequency band are rapidly scanned in real time by all the acoustic sensors, and the (acoustic intensity, frequency) pair linked with the GPS determined sensor orientation at the sampling time. The resulting data is then sent to the command unit 120 for generation of the situation map.

The acoustic sensor array in the system 10 can thus provide (i) the current location(s) and immediate past movement of each acoustic sensor 20 as well as identify unfriendly dismounts/law enforcement officers in close quarter combat/reconnaissance, including urban, rural and marine environments and (ii) the current location(s) and movements of inter-agency forces and potential non-combatants, during the deployment of multi-national forces and from multiple agencies, including non-law enforcement resources, such as fire and paramedical services to active situations. The monitoring system 10 can further covertly monitor speech with localization of the specific target across the entire zone of acoustic sensor deployment, including urban warfare, crowd surveillance, hostage situations, diplomatic/close protection, embassy external monitoring, federal/state building and historic properties surveillance, unattended border monitoring and pre-clearance surveillance at attended crossings (e.g., airports, bridges, roadways), prisons, etc; as well as localize and identify weapon systems being fired during the monitored period; and locate acoustic barriers indicative of physical obstacles such as buildings, walls, berms, etc., which provide potential cover for suspects and friendly forces (e.g., alleyways, dumpster boxes, “spider holes”). The monitoring system 10 can further provide current locations and immediate past movement of motorized armament, vehicles, and small craft, under urban warfare or high value property surveillance and recovery conditions, e.g., tracking of stolen decoy vehicles.

It is also contemplated the frequency pattern of specific sounds generated in the theatre of operations can be recorded, cataloged and compared to future monitored frequency spectra to identify threats, such as specific weapons discharge and the level of aggression such as weapon deployment activities (e.g., loading, cocking, and discharge), vehicle velocity, soldier dismount, or turret movement. That is, the library of spectral distribution characteristics such as stored in the command unit 120 can be dynamically modified or updated, so that subsequent spectral analysis of received acoustic signals provides information such as whether there are motorized armament, vehicles, or small craft present, identification of weapons that have been fired, and estimates of crowd size for threat level assessment.

While the invention has been described in connection with a presently preferred embodiment thereof, those skilled in the art will recognize that many modifications and changes made be made therein without departing from the spirit and scope of the invention, which accordingly is intended to be defined solely by the appended claims.

1. An acoustic monitoring system for locating an acoustic event in an environment surrounding the acoustic monitoring system, the acoustic monitoring system comprising:
(a) an acoustic sensor comprising:
i. a pair of microphones separated by a predetermined distance, the microphones facing each other on a microphone axis MA, the microphone pair generating a signal corresponding to an acoustic intensity and a sound spectra corresponding to the acoustic event arriving at each microphone relative to the microphone axis, the sound spectra received at each microphone as an individual spectra in front of and behind the microphone pair, at a given time and global location;
ii. a microprocessor in communication with the microphone pair;
iii. an absolute clock in communication with the microprocessor and providing a synchronized time to the microprocessor;
iv. a position sensor for detecting an absolute global position of the microphone pair and an absolute axis orientation of the microphone pair; and
(b) a command unit in communication with the microprocessor, wherein the acoustic event received at the microphone pair results in the acoustic sensor transmitting to the command unit a time of arrival, a microphone pair absolute global position, a microphone pair axis orientation, and a signal corresponding to an angle of incidence of the acoustic event relative to the microphone axis MA.

2. The acoustic monitoring system of claim 1, wherein the acoustic sensor transmits data corresponding to a plurality of dynamically determined frequencies within the sound spectra.

3. The acoustic monitoring system of claim 1, further comprising a relative clock in communication with the microprocessor, the relative clock providing synchronized time to a second acoustic sensor.

4. The acoustic monitoring system of claim 3, wherein the second acoustic sensor includes a second absolute clock, the second absolute clock in communication with the relative clock.

5. The acoustic monitoring system of claim 3, wherein the acoustic sensor is configured to obtain a transmitted absolute time from the second acoustic sensor in response to a loss of synchronization from the absolute clock.

6. The acoustic monitoring system of claim 1, wherein the microprocessor is configured to determine a vector to the acoustic event.

7. The acoustic monitoring system of claim 1, further comprising means for providing a scalar quantity of sound pressure level.

8. The acoustic monitoring system of claim 1 wherein the absolute clock comprises a GPS receiver.

9. The acoustic monitoring system of claim 1, wherein the acoustic sensor includes a remote transceiver and the command unit includes a central transceiver for communication with the remote transceiver.

10. The acoustic monitoring system of claim 9, wherein the remote transceiver and the central transceiver communicate using at least one frequency between sub-sonic and microwave.

11. The acoustic monitoring system of claim 1, wherein the absolute clock comprises a GPS receiver and the GPS receiver communicates the absolute global position of the acoustic sensor to the microprocessor.

12. The acoustic monitoring system of claim 1, wherein the absolute clock comprises a GPS receiver and the GPS receiver provides a reference absolute axis for determination of the microphone axis MA relative to the absolute reference axis.

13. The acoustic monitoring system of claim 1, further comprising a power supply operably connected to the microprocessor.

14. The acoustic monitoring system of claim 13, wherein the power supply comprises one of a lithium battery, a solid oxide fuel cell, a microchannel energy generator, a fuel storage and delivery unit, a battery and a capacitive storage device.

15. The acoustic monitoring system of claim 1, further comprising a network interface connected to the microprocessor, the network interface comprising one of an encrypted, a trunked and a frequency agile radio frequency transceiver.

16. The acoustic monitoring system of claim 1, further comprising a network interface connected to the microprocessor, wherein the network interface is configured to encrypt data and to connect to an Ethernet network.

17. The acoustic monitoring system of claim 1, further comprising a network interface connected to the microprocessor, wherein the network interface is configured to communicate over one of a cellular telephone network, an acoustic network, an optical network, a cable network, a ground wave, an airwave and a co-channeled power utility.

18. A method for locating and identifying an acoustic source producing an acoustic signal, the method comprising:
(a) spacing a first acoustic sensor and a second acoustic sensor from each other and the acoustic event, each of the first and the second acoustic sensor comprising;
i. a microprocessor;
ii. a microphone pair connected to the microprocessor, the microphone pair located in an opposing orientation along a microphone axis in the acoustic sensor, the microphone pair presenting to the microprocessor a sound spectra corresponding to the acoustic signal, the microprocessor determining an angle of incidence to the acoustic source and identifying at least one frequency focal point within the sound spectra;
iii. an absolute clock in communication with the microprocessor, the absolute clock providing a synchronized time to the microprocessor;
iv. a transceiver in communication with the microprocessor for receiving relative clock signals, such that the microprocessor can obtain synchronized time from the relative time clock to match similar sound frequencies received simultaneously at the first and second acoustic sensor;
v. a network interface in communication with the microprocessor, the network interface selected to communicate over a network;
(b) receiving at the first acoustic sensor the acoustic signal corresponding to the acoustic source;
(c) creating at the first acoustic sensor a signal corresponding to an incidence angle between the first acoustic sensor and the acoustic source, with respect to an absolute time and axis position of the first acoustic sensor;
(d) transmitting from the first acoustic sensor to a command unit data corresponding to the incidence angle; and
(e) transmitting from the command unit to the second acoustic sensor instructions to detect the acoustic source and in response to the acoustic signal, provide an incidence angle between the acoustic source and the second acoustic sensor with respect to the absolute axis of the second acoustic sensor and a global position of the second acoustic sensor.

19. The method of claim 18, further comprising transmitting from the first acoustic sensor a frequency focal point within the acoustic signal.

20. The method of claim 19, further comprising reporting to the command unit an incidence angle between the acoustic source and the second acoustic sensor with respect to the absolute axis of the second acoustic sensor and a global position of the second acoustic sensor corresponding to the frequency focal point at the absolute time at that time.

21. The method of claim 18, further comprising identifying at the first acoustic sensor a plurality of frequency focal points and communicating the plurality of frequency focal points to the command unit.

22. The method of claim 18, further comprising identifying at the first acoustic sensor a plurality of frequency focal points and an incidence angle corresponding to each of the plurality of frequency focal points.

23. The method of claim 18, further comprising moving one of the first acoustic sensor and the second acoustic sensor.

24. A system for monitoring an acoustic signal from an acoustic event, the system comprising:
(a) a movable first acoustic sensor comprising:
i. a microphone pair fixed in an opposing orientation along a microphone axis, the microphone pair producing a signal indicative of an incidence angle with respect to an absolute point in time axis position of the first acoustic sensor at a given absolute global position, the microphone pair producing an individual sound spectra from the front and rear of the microphone pair;
ii. a microprocessor in communication with the microphone pair, the microprocessor determining an incidence angle with respect to an absolute axis position for each of a plurality of frequency focal points at the given absolute global position;
iii. an absolute clock in communication with the microprocessor, the absolute clock providing a synchronized time to the microprocessor to match sequentially received sound frequencies at different absolute global positions of the acoustic sensor; and
(b) a command unit in communication with the microprocessor, the command unit configured to receive the incidence angle from the first acoustic sensor.

25. The system of claim 24, wherein the command unit is configured to receive a plurality of incidence angles with respect to the corresponding absolute axis and the absolute global position of the first acoustic sensor at a plurality of spectral frequency focal points.

26. The system of claim 24, further comprising a second acoustic sensor in communication with the command unit, the command unit configured to determine a location of the acoustic event in response receiving a time of arrival from the first acoustic sensor.

27. The system of claim 24, wherein the command unit is configured to determine a location of the acoustic event in response to the communication from the first acoustic sensor.

28. A method for locating the source of an acoustic event comprising the steps of:
(a) disposing two acoustic sensors at spaced locations, each acoustic sensor comprising:
i. a microphone pair disposed in an opposing orientation a fixed distance apart along a microphone axis;
(b) transmitting data from each acoustic sensor to a command unit, the transmitted data including a time of arrival of the acoustic event corresponding to one of a synchronized clock and a relative clock, an incidence angle and corresponding frequency for the time of arrival; and
(c) determining at the command unit the location of the acoustic event in response to transmitted data.

29. A method for determining spatial uncertainty from the presence of a sound transmission path modification of acoustic signals from an acoustic event, the method comprising the steps of:
(a) receiving the acoustic signals at a first and a second acoustic sensor, each acoustic sensor including a pair of opposing microphones in a fixed spacing on a microphone axis;
(b) reducing ambient acoustic interference from the acoustic signals;
(c) creating a digital representation of the acoustic signals, each digital representation including one of a frequency peak and a plurality of frequency peaks;
(d) transmitting the digital representation and a corresponding time of arrival to a command unit; and
(e) associating the time of arrival from the first and the second acoustic sensor, and in response to a non correlation of the time of arrival between the one of the individual frequency peak and the plurality of frequency peaks with the digital representation having the shortest time of arrival, assessing of one of (i) the acoustic signals arrived at the second acoustic sensor by a non-direct path and (ii) a time of arrival representing an error greater than a predetermined level in a calculated triangulation of the acoustic signals.

30. A method for identifying a detected acoustic event, the method comprising the steps of:
(a) receiving acoustic signals from the acoustic event at an acoustic sensor;
(b) reducing ambient acoustic event interference from the received acoustic signals and converting the received acoustic signals to a digital representation; and
(c) correlating the digital representation to a stored spectral distribution to identify the acoustic event.

31. The method of claim 30, wherein correlating the digital representation to a stored spectral distribution includes correlating characteristics of the digital representation, frequency peaks, time between frequency peaks and signal duration with the characteristics of the stored spectral distribution.

32. A method of monitoring a noise source, the method comprising:
(a) measuring at a pair of spaced locations an incidence angle of the noise source, each location including an acoustic sensor having a pair of concentric opposing microphones at a fixed distance on a microphone axis; and
(b) determining a position of the noise source corresponding to the measured incidence angles.

33. The method of claim 32, further comprising coupling each acoustic sensor to a global positioning system.

34. The method of claim 32, further comprising measuring a sound spectra of the acoustic event and comparing the sound spectra to predetermined acoustic signatures.

35. A method of monitoring a noise source, the method comprising:
(a) measuring at a pair of spaced locations an acoustic intensity of a sound, each location including an acoustic sensor having a pair of concentric opposing microphones at a fixed distance on a microphone axis; and
(b) determining a position of the noise source corresponding to the measured acoustic intensities.

36. An apparatus for monitoring a noise source, the apparatus comprising:
(a) a first and a second acoustic sensor, each acoustic sensor including a pair of concentric opposing microphones at a fixed distance on a microphone axis; and
(b) a command unit in communication with the first and the second acoustic sensor, the command unit selected to determine a location of the noise source relative to at least one of the first and the second acoustic sensors.
